(19) United States
(12) Patent Application Publication
(10) Pub. No.: US 2013/0260210 A1
(43) Pub. Date: Oct. 3, 2013

(54) NONAQUEOUS ELECTROLYTE BATTERY AND BATTERY PACK

(71) Applicants: Norio TAKAMI, Yokohama-shi (JP); Hiroki Inagaki, Yokohama-shi (JP); Yasuhiro Harada, Yokohama-shi (JP)

(72) Inventors: Norio TAKAMI, Yokohama-shi (JP); Hiroki Inagaki, Yokohama-shi (JP); Yasuhiro Harada, Yokohama-shi (JP)

(21) Appl. No.: 13/729,546

(22) Filed: Dec. 28, 2012

(30) Foreign Application Priority Data
Mar. 28, 2012 (JP) 2012-074801

(51) Int. Cl. H01M 10/0525

(52) U.S. Cl. CPC H01M 10/0525
USPC 429/156; 429/221

(57) ABSTRACT

According to one embodiment, a nonaqueous electrolyte battery includes a positive electrode, a negative electrode and a nonaqueous electrolyte. The positive electrode includes a compound, which is represented by LiFe₁₋ₓMnₓSO₄F wherein 0≦x≦0.2, and has at least one kind of crystal structure selected from tavoraite and triplite. The negative electrode includes a titanium-containing oxide.

### CROSS-REFERENCE TO RELATED APPLICATIONS

This application is based upon and claims the benefit of priority from Japanese Patent Application No. 2012-074801, filed Mar. 28, 2012, the entire contents of which are incorporated herein by reference.

### FIELD

Embodiments described herein relate generally to a nonaqueous electrolyte battery and a battery pack.

### BACKGROUND

Lithium ion batteries including a positive electrode containing a lithium-containing metal oxide such as LiCoO₂ or LiMn₂O₄ and a negative electrode containing a carbonaceous material, which absorbs and releases lithium ions, are widely used as a power source for driving mobile devices. Whereas, batteries used for automobiles or systems for storing electricity are required to have storage characteristic in a high temperature environment, float charge resistance, cycle life performance, high output power, safety, long-term reliability, and the like. For that reason, materials having excellent chemical stability and electrochemical stability are required for materials forming the positive electrode and the negative electrode in the lithium ion battery. LiFePO₄ has been investigated as the positive electrode material. In this case, however, high-temperature durability and performance deterioration in a low temperature environment become issues. High performance is also required in cold districts for car use, and for example high output performance in a low-temperature (for example, −40° C.) environment, and cycle life performance are required. On the other hand, although lead storage batteries (12 V) have been widely used for batteries in starters for automobiles and systems for storing electricity for a long time, substitution for the lead storage battery has been studied in order to reduce a battery weight and free from using lead. Substitute batteries for the lead storage battery, however, have not been realized yet.

Batteries, which are mounted on automobiles (for car use) or systems for storing electricity (for stationary) instead of the lead storage battery, accordingly, have issues of high-temperature durability, float charge resistance and low-temperature output performance. It is difficult to introduce an existing battery, which is a substitute battery for the lead storage battery, in an engine room of an automobile and to use it as a power source of a starter.

### BRIEF DESCRIPTION OF THE DRAWINGS

FIG. 1 is a partially cut-away cross-sectional view showing a nonaqueous electrolyte battery of an embodiment;

FIG. 2 is a side view showing the battery in FIG. 1;

FIG. 3 is a perspective view showing one embodiment of a battery module used in a battery pack of an embodiment;

FIG. 4 is a graph showing a relationship between a depth of discharge and a battery voltage of a battery of Example 1 and batteries of Comparative Examples 1, 2 and 5; and

FIG. 5 is a graph showing a relationship between a depth of discharge, a positive electrode potential and a negative electrode potential in Examples 1 and 2 and Comparative Example 2.

### DETAILED DESCRIPTION

According to one embodiment, a nonaqueous electrolyte battery includes a positive electrode, a negative electrode and a nonaqueous electrolyte. The positive electrode includes a compound, which is represented by LiFe₁₋ₓMnₓSO₄F wherein 0≦x≦0.2, and has at least one kind of crystal structure selected from tavoraite and triplite. The negative electrode includes a titanium-containing oxide.

Referring to the drawings, embodiments will be explained below.

### First Embodiment

According to a first embodiment, a nonaqueous electrolyte battery including a positive electrode, a negative electrode, and a nonaqueous electrolyte is provided. The negative electrode includes a titanium-containing oxide. This negative electrode has a high flatness in a charge potential curve and a discharge potential curve, but the charge and discharge potentials are suddenly changed at their respective last stage. For this reason, if an oxide having an olivine structure such as LiFePO₄ is only used as a positive electrode active material, the charge and discharge potentials of the resulting positive electrode are suddenly changed at their respective last stage, similar to the negative electrode. A voltage of a battery using such a positive electrode and a negative electrode is, accordingly, also suddenly changed at the last stage of charge and the last stage of discharge, and, as a result, it is difficult to detect a capacity, SOC (state of charge), SOD (state of discharge) or a depth of discharge (DOD) by a battery voltage variation. The positive electrode in the embodiment includes a compound represented by LiFe₁₋ₓMnₓSO₄F wherein 0≦x≦0.2, and having at least one kind of crystal structure selected from a tavoraite crystal structure and a triplite crystal structure (hereinafter referred to as a lithium-iron-manganese compound), the positive electrode potential is gradually changed at the last stage of charge and the last stage of discharge, respectively. When this positive electrode is combined with the negative electrode, the voltage variation curve can be gentle at the last stage of charge and the last stage of discharge, respectively, and therefore it is easy to detect the capacity, SOC, SOD or DOD by the battery voltage variation, and overcharge and over discharge can be prevented.

According to the embodiment, a reaction between the positive electrode and the nonaqueous electrolyte can be suppressed in a high-temperature environment or during float charge, thus resulting in suppressed growth of a film generated on the surface of the positive electrode. This can suppress increase of an interface resistance on the positive electrode, and thus the life performance can be improved in a high-temperature charge and discharge cycles with the float charge up to an SOC as high as 100%. Furthermore, discharge rate performance can be improved in a low-temperature environment (for example, −20° C. or less).

An intermediate voltage of the battery in the embodiment is about 2 V, which is almost the same value as that obtained in a lead storage battery. The battery of the embodiment, therefore, is excellent in compatibility with the lead storage battery, and a battery pack using a battery module in which 6 batteries of the embodiment are connected in series can realize a voltage of 12 V, which can be substituted for the lead storage battery. When this battery pack is introduced in an engine room of an automobile instead of a lead storage battery, a smaller and lighter engine having a longer life can be attained compared to a case in which the lead storage battery is used.

In order to improve the output performance at a low temperature, it is preferable to reduce a particle size of a lithium-iron-manganese compound. When the particle size of the lithium-iron-manganese compound is reduced, however, reactivity between nonaqueous electrolyte and moisture becomes larger. When at least a part of the surface of the particles of the lithium-iron-manganese compound is covered with a coating including at least one kind of material selected from the group consisting of a carbon material, a phosphorus compound, a fluoride and a metal oxide, the reactivity between the nonaqueous electrolyte and the moisture can be reduced in the case in which the particle size is reduced. Thus oxidative decomposition of the nonaqueous electrolyte in the float charge up to 100% SOC and the reaction with moisture in the air can be suppressed. This can greatly improve the cycle life performance of the battery when the lithium-iron-manganese compound particles are used, and thus the discharge rate performance of the battery can be greatly improved in a low-temperature environment (for example, −20° C. or less).

The positive electrode, the negative electrode, the nonaqueous electrolyte, a separator and a case will be explained below.

### (Positive Electrode)

This positive electrode has a positive electrode current collector, and a positive electrode material layer(s) (positive electrode active material-containing layer), which is formed on one side or both sides of the current collector and includes a positive electrode active material, a conductive agent and a binder.

The positive electrode active material includes a compound represented by LiFe₁₋ₓMnₓSO₄F wherein 0≦x≦0.2, which has at least one kind of crystal structure selected from a tavoraite crystal structure and a triplite crystal structure (lithium-iron-manganese compound).

When the range of x exceeds 0.2, either property of the high-temperature durability, the float charge resistance and the low-temperature output performance is deteriorated. When x is within a range of 0≦x≦0.1, the tavoraite crystal structure can be easily obtained. When x is within a range of 0.1≦x≦0.2, the triplite crystal structure can also be easily obtained. The lithium-iron-manganese compound having the tavoraite crystal structure can adjust a lithium absorption potential to 3.55 V (vs. Li/Li⁺). The lithium-iron-manganese compound having the triplite crystal structure can adjust the lithium absorption potential to 3.85 V (vs. Li/Li⁺). A lithium titanium oxide having a spinel structure, represented by Li_{4/3+x}Ti_{5/3}O₄ wherein 0≦x≦1, has a lithium absorption potential of 1.55 V (vs. Li/Li⁺). When the negative electrode including the lithium titanium oxide having the spinel structure is combined with the positive electrode including the lithium-iron-manganese compound having the tavoraite crystal structure, an intermediate voltage of about 2 V can be realized, and thus a battery having excellent compatibility with a lead storage battery can be realized. When the tavoraite crystal structure is adopted, accordingly, a battery having excellent high-temperature durability, float charge resistance, low-temperature output performance, and compatibility with a lead storage battery can be realized.

The primary particles of the lithium-iron-manganese compound has preferably an average primary particle size within a range of 0.05 μm or more and 1 μm or less. A more preferable range thereof is 0.01 μm or more and 0.5 μm or less. When the primary particle size is within this range, a diffusion resistance of lithium ions in the active material can be reduced, thus resulting in the improved output performance. The lithium-iron-manganese compound may include secondary particles, in which the primary particles are aggregated, having a size of 10 μm or less.

The lithium-iron-manganese compound may be synthesized, for example, by the following method.

FeSO₄.7H₂O and MnSO₄.H₂O are mixed in a pre-determined stoichiometric ratio, and the mixture is dehydrated at a temperature of 80° C. or higher and 150° C. or lower in vacuo. Then, LiF is added thereto in a pre-determined stoichiometric ratio, and the mixture is pressure-molded into pellets. After that, the pellets are subjected to a heat-treatment at a temperature of 200° C. or higher and 350° C. or lower in a nitrogen atmosphere. The obtained product is pulverized in a dry atmosphere into particles with a pre-determined particle size, thereby obtaining the lithium-iron-manganese compound. When x, a molar ratio of Mn, is adjusted to a range of 0≦x≦0.1 in this synthesis method, the tavoraite crystal structure can be obtained. Also, when x is adjusted to a range of 0.1≦x≦0.2, the triplite crystal structure can be obtained.

At least a part of the surface of the particles of the lithium-iron-manganese compound can be covered with a coating including at least one kind of material selected from the group consisting of a carbon material, phosphorus compounds, fluorides and metal oxides. The particles may be any state of primary particles and secondary particles. The carbon material may include a carbonaceous material having a d₀₀₂ of 0.344 nm or more. The phosphorus compound may include lithium phosphate (Li₃PO₄), aluminum phosphate (AlPO₄), SiP₂O₇, and the like. The fluoride may include lithium fluoride (LiF), aluminum fluoride (AlF₃), iron fluoride (FeF_{X} in which 2≦X≦3), and the like. The metal oxide may include Al₂O₃, ZrO₂, SiO₂, TiO₂, and the like.

The shape of the coating may include particles, layers, and the like. When the coating is in the shape of a particle, the particle size thereof is preferably 0.1 μm or less, more preferably 0.01 μm or less. When the coating is in the shape of a layer, the thickness thereof is preferably 0.1 μm or less, more preferably 0.01 μm or less.

The amount of the coating is preferably 0.001% by mass or more and 3% by mass or less based on the amount of the lithium-iron-manganese compound. When the amount of the coating is 0.001% by mass or more, the increase of the positive electrode resistance can be suppressed, thus resulting in the improved output performance. On the other hand, when the amount of coating is 3% by mass or less, the increase of the interfacial resistance between the positive electrode and the nonaqueous electrolyte can be suppressed, thus resulting in the improved output performance. The amount of the coating is more preferably within a range of 0.01% by mass or more and 1% by mass or less.

The positive electrode active material may include materials other than the lithium-iron-manganese compound. Examples of the other positive electrode active material may be exemplified by various oxides and sulfides including, for example, manganese dioxide (MnO₂), iron oxides, copper oxides, nickel oxides, lithium-manganese composite oxides, lithium-nickel composite oxides (e.g., LiₓNiO₂), lithium-cobalt composite oxides (e.g., LiₓCoO₂), lithium-nickel-cobalt composite oxides (e.g., LiNi_{1-y-z}Co_{y}M_{z}O₂ wherein M is at least one element selected from the group consisting of Al, Cr and Fe, 0≦y≦0.5, and 0≦z≦0.1), lithium-manganese-cobalt composite oxides (e.g., LiMn_{1-y-z}Co_{y}M_{z}O₂, wherein M is at least one element selected from the group consisting of Al, Cr and Fe, 0≦y≦0.5, and 0≦z≦0.1), lithium-manganese-nickel composite compounds (e.g., LiMnₓNiₓM₁₋₂ₓO₂, wherein M is at least one element selected from the group consisting of Co, Cr, Al and Fe, and ⅓≦x≦½, such as LiMn_{1/3}Ni_{1/3}Co_{1/3}O₂, or LiMn_{1/2}Ni_{1/2}O₂), spinel type lithium-manganese-nickel composite oxides (LixMn_{2-y}Ni_{y}O₄), lithium metal phosphorus oxides having an olivine structure, iron sulfates (e.g., Fe₂(SO₄)₃), vanadium oxides (e.g., V₂O₅), and the like. In addition, it may also include conductive polymer materials such as polyaniline and polypyrrole, disulfide polymer materials, sulfur (S), organic materials such as carbon fluoride, and inorganic materials. When the preferable ranges of x, y and z are not described, a range of 0 or more and 1 or less is preferable. The positive electrode active material may be used alone or as a mixture of two kinds or more thereof.

The conductive agent may include, for example, acetylene black, carbon black, graphite, carbon fiber, and the like.

The binder may include, for example, polytetrafluoroethylene (PTFE), polyvinylidene fluoride (PVdF), fluorine-containing rubber, and the like.

The mixing ratios of the active material, the conductive agent and the binder in the positive electrode are preferably that the ratio of the positive electrode active material is within a range of 80 to 95% by mass, the ratio of the conductive agent is within a range of 3 to 19% by mass, and the ratio of the binder is within a range of 1 to 7% by mass.

The positive electrode may be produced by, for example, suspending the positive electrode active material, the conductive agent and the binder in an appropriate solvent, coating a current collector of an aluminum foil or aluminum alloy foil with the resulting suspension, drying it, and pressing it. A specific surface area of the positive electrode material layer in accordance with a BET method refers to a surface area per g of the positive electrode material layer (excluding a current collector mass), and it is preferably within a range of 0.1 m²/g or more and 2 m²/g or less.

The current collector may include an aluminum foil, an aluminum alloy foil, and the like. The current collector has a thickness of 20 μm or less, more preferably 15 μm or less.

### (Negative Electrode)

This negative electrode has a negative electrode current collector, and a negative electrode material layer, which is supported on one side or both sides of the current collector and includes an active material, a conductive agent and a binder.

The negative electrode active material includes a lithium titanium oxide. The lithium titanium oxide may include a lithium titanium oxide having a spinel structure, represented by Li_{4/3+x}Ti_{5/3}O₄ wherein 0≦x≦1; a titanium oxide having a bronze structure (B) or an anatase structure, represented by LiₓTiO₂ wherein 0≦x≦1 (a composition before charge is TiO₂); a niobium titanium oxide represented by LiₓNbₐTiO₇ wherein 0≦x, more preferably 0≦x≦1, and 1≦a≦4; and Li₂₊ₓTi₃O₇ (0≦x≦1) having a ramsdellite structure; Li₁₊ₓTi₂O₄ wherein 0≦x≦1; Li_{1.1+x}Ti_{1.8}O₄ wherein 0≦x≦1; Li_{1.07+x}Ti_{1.86}O₄ wherein 0≦x≦1; and the like. The preferable titanium oxide represented by LiₓTiO₂ includes TiO₂ having the anatase structure and TiO₂ (B) having the bronze structure. Low-crystalline oxides which are heat-treated at a temperature of 300 to 600° C. are also preferable. Besides the compounds described above, compounds in which a part of Ti component in the lithium titanium oxide is substituted by at least one element selected from the group consisting of Nb, Mo, W, P, V, Sn, Cu, Ni and Fe may be used.

The primary particles of the negative electrode active material has preferably an average primary particle size within a range of 0.001 μm or more and 1 μm or less. Good properties can be obtained in any shape of the particles such as a granule or fiber. A fiber diameter of the particles is preferably 0.1 μm or less.

A desirable negative electrode active material has an average particle size of 1 μm or less, and a specific surface area of 3 to 200 m²/g, which is measured according to a BET method by N₂ adsorption. This can further enhance affinity of the negative electrode with the nonaqueous electrolyte.

The specific surface area according to the BET method of the negative electrode material layer (excluding the current collector) can be adjusted to 3 m²/g or more and 50 m²/g or less. The specific surface area is more preferably within a range of 5 m²/g or more and 50 m²/g or less.

The negative electrode (excluding the current collector) has desirably a porosity within a range of 20 to 50%. This can provide a negative electrode having high affinity thereof with the nonaqueous electrolyte and a high density. The porosity is more preferably within a range of 25 to 40%.

The negative electrode current collector is formed of desirably an aluminum foil or an aluminum alloy foil.

The aluminum foil or the aluminum alloy foil has a thickness of 20 μm or less, more preferably 15 μm or less. The aluminum foil has preferably a purity of 99.99% by mass or more. Aluminum alloys including at least one kind of element selected from the group consisting of magnesium, zinc and silicon are preferable. Whereas, it is preferable to adjust a content of a transition metal such as iron, copper, nickel or chromium to 100 ppm by mass or less.

The conductive agent may include, for example, acetylene black, carbon black, coke, carbon fibers, graphite, metal compound powders, metal powders, and the like, and they may be used alone or as a mixture thereof. More preferable conductive agents may include the coke, heat-treated at a temperature of 800° C. to 2000° C. and have an average particle size of 10 μm or less, the graphite, the acetylene black and the metal powders of TiO, TiC, TiN, Al, Ni, Cu, Fe, or the like.

The binder may include, for example, polytetrafluoroethylene (PTFE), polyvinylidene fluoride (PVdF), fluorine-containing rubber, acrylic rubber, styrene-butadiene rubber, a core-shell binder, and the like.

The mixing ratios of the active material, the conductive agent and the binder in the negative electrode are preferably that the ratio of the negative electrode active material is within a range of 80 to 95% by mass, the ratio of the conductive agent is within a range of 1 to 18% by mass, and the ratio of the binder is within a range of 2 to 7% by mass.

The negative electrode can be produced by, for example, suspending the negative electrode active material, the conductive agent and the binder in an appropriate solvent, coating the current collector with the resulting suspension, drying it and heat-pressing it.

### (Nonaqueous Electrolyte)

The nonaqueous electrolyte may include liquid nonaqueous electrolyte prepared by dissolving electrolyte in an organic solvent; gelatinous nonaqueous electrolyte in which an organic solvent and a polymeric material are combined, and solid nonaqueous electrolyte in which a lithium salt electrolyte and a polymeric material are combined. A room temperature molten salt including lithium ions (ionic liquid) may also be used as the nonaqueous electrolyte. The polymeric material may include, for example, polyvinylidene fluoride (PVdF), polyacrylonitrile (PAN), polyethylene oxide (PEO), and the like.

As the liquid nonaqueous electrolyte, organic electrolytic solutions and room temperature molten salts (ionic liquid) having a solidifying point of −20° C. or lower and a boiling point of 100° C. or higher are preferable.

The liquid nonaqueous electrolyte is prepared by dissolving the electrolyte in a concentration of 0.5 to 2.5 mol/L in an organic solvent.

The electrolyte may include, for example, LiBF₄, LiPF₆, LiAsF₆, LiClO₄, LiCF₃SO₃, LiN(CF₃SO₂)₂, LiN(C₂F₅SO₂)₂, Li(CF₃SO₂)₃C, LiB[(OCO)₂]₂, and the like. The kind of the electrolyte used can be made one kind or two or more kinds. The electrolyte including at least one of LiPF₆ and LiBF₄ is preferable. Such an electrolyte enhances the chemical stability of the organic solvent, can reduce the film resistance on the negative electrode, and can remarkably improve the low-temperature performance and the cycle life performance.

The organic solvent may include, for example, cyclic carbonates such as propylene carbonate (PC) and ethylene carbonate (EC); linear carbonates such as diethyl carbonate (DEC), dimethyl carbonate (DMC) and methyl ethyl carbonate (MEC); linear ethers such as dimethoxyethane (DME) and diethoxyethane (DEE); cyclic ethers such as tetrahydrofran (THF) and dioxolane (DOX); γ-butyrolactone (GBL), acetonitrile (AN), sulfolane (SL), and the like. These organic solvents may be used alone or as a mixture of two or more kinds thereof. Organic solvents including at least one kind of solvent selected from the group consisting of propylene carbonate (PC), ethylene carbonate (EC) and γ-butyrolactone (GBL) are preferable, because the nonaqueous electrolyte has a boiling point of 200° C. or higher and thus has high heat-stability when using them. When the organic solvent includes at least one kind of solvent selected from the group consisting of γ-butyrolactone (GBL), diethoxyethane (DEE) and diethyl carbonate (DEC), a lithium salt can be used in a high concentration, and thus the output performance can be enhanced in a low-temperature environment. It is preferable to dissolve the lithium salt in a concentration within a range of 1.5 to 2.5 mol/L relative to the organic solvent. This concentration range can provide a high output power even in a low-temperature environment.

The room temperature molten salt refers to a salt at least a part of which shows a liquid state at a room temperature, and a room temperature refers to a temperature range at which a power source can usually be supposed to work. The temperature range at which the power source can usually be supposed to work is a range in which the upper limit thereof is about 120° C., sometimes about 60° C., and the lower limit is about −40° C., sometimes about −20° C. Of these, a range of −20° C. or higher and 60° C. or lower is appropriate. The room temperature molten salt (ionic melt) is preferably formed of lithium ions, organic substance cations and organic substance anions. In addition, the room temperature molten salt is desirably in the state of liquid at room temperature or lower.

The organic substance cations may include alkyl imidazolium ions having a backbone shown in Chem. 1 below, and quaternary ammonium ions.

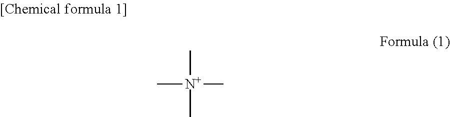

Preferable alkyl imidazolium ions may include dialkyl imidazolium ions, trialkyl imidazolium ions, tetraalkyl imidazolium ions. Preferable dialkyl imidazolium may include 1-methyl-3-ethyl imidazolium ions (MEI⁺). Preferable trialkyl imidazolium ions may include 1,2-diethyl-3-propyl imidazolium ions (DMPI+). Preferably tetraalkyl imidazolium ions may include 1,2-diethyl-3,4(5)-dimethyl imidazolium ions.

Preferable quaternary ammonium ions may include tetraalkyl ammonium ions and cyclic ammonium ions. Preferable tetraalkyl ammonium ions may include dimethyl ethyl methoxyethyl ammonium ions, dimethyl ethyl methoxymethyl ammonium ions, dimethyl ethyl ethoxyethyl ammonium ions, and trimethyl propyl ammonium ions.

When the alkyl imidazolium ions or the quaternary ammonium ions (especially tetraalkyl ammonium ions) are used, the melting point can be adjusted to 100° C. or lower, more preferably 20° C. or lower, and further the reactivity with the negative electrode can be reduced.

The concentration of the lithium ions is preferably 20% by mol or less, more preferably from 1 to 10% by mol. When the concentration is adjusted to the range described above, the liquid room temperature molten salt can be easily obtained even at a low temperature such as 20° C. or lower. Also, the viscosity can be reduced even at a room temperature or lower, thus resulting in the enhanced ion conductivity.

As the anion, at least one kind of anion selected from the group consisting of BF₄⁻, PF₆⁻, AsF₆⁻, ClO₄⁻, CF₃SO₃⁻, CF₃COO⁻, CH₃COO⁻, CO₃²⁻, (FSO₂)2N⁻, N(CF₃SO₂)₂⁻, N(C₂F₅SO₂)₂⁻ and (CF₃SO₂)₃C⁻ is preferable. When multiple kinds of anions coexist, a room temperature molten salt having a melting point of 20° C. or lower can be easily formed. More preferable anions may include BF₄⁻, (FSO₂)₂N⁻, CF₃SO₃⁻, CF₃COO⁻, CH₃COO⁻, CO₃²⁻, N(CF₃SO₂)₂⁻, N(C₂F₅SO₂)₂⁻ and (CF₃SO₂)₃C⁻. When these anions are used, a room temperature molten salt can be more easily obtained at 0° C. or lower.

### (Separator)

A separator can be located between the positive electrode and the negative electrode. As the separator, for example, synthetic resin non-woven fabrics, cellulose non-woven fabrics, or polyolefin porous membranes (e.g., polyethylene porous films, and polypropylene porous films) may be used. The preferable separator includes polyolefin porous membranes and cellulose fiber non-woven fabrics.

The separator has preferably a porosity of 50% or more.

The separator has preferably a thickness of 10 to 100 μm and a density of 0.2 to 0.9 g/cm³. When the physical properties are within the ranges described above, well-balanced between increase of the mechanical strength and decrease of the battery resistance can be obtained, and a battery which having the high output power and a property in which occurrence of an internal short-circuit is reduced can be provided. The thermal shrinkage is small in a high-temperature environment and the good high-temperature storage characteristic can also be obtained.

It is preferable to use a cellulose fiber separator having a porosity of 60% or more. The separator may be in the state of a non-woven fabric having a fiber diameter of 10 μm or less, a film, paper or the like. In particular, the cellulose fiber separator having a porosity of 60% or more have a good impregnating ability with the electrolyte, and can exhibit the high output performance at from a low temperature to a high temperature. A more preferable range is from 62% to 80%. In addition, the cellulose fiber separator having a porosity of 60% or more is not reacted with the negative electrode during long-term storage in a charged state, float charge and over charge, and can prevent an internal short-circuit, which is caused by deposition of a dendrite of lithium metal. Furthermore, when the fiber diameter is 10 μm or less, the affinity with the nonaqueous electrolyte is improved, thus resulting in the reduced battery resistance. The fiber diameter is more preferably 3 μm or less.

### (Case)

Cases formed from a metal or a laminate film can be used as a case for housing the positive electrode, the negative electrode and the nonaqueous electrolyte.

A case formed from aluminum, an aluminum alloy, iron or stainless steel and being in the shape of a rectangle or a cylinder can be used as the metal case. The case has desirably a plate thickness of 0.5 mm or less, more preferably 0.3 mm or less.

The laminate film may include, for example, multi-layer films in which an aluminum foil is covered with a resin film, and the like. Examples of the resin may include polymers such as polypropylene (PP), polyethylene (PE), nylon, and polyethylene terephthalate (PET). The laminate film has preferably a thickness of 0.2 mm or less. The aluminum foil has preferably a purity of 99.5% by mass or more.

It is preferable to form the metal can of an aluminum alloy from an alloy including at least one kind of element selected from the group consisting of manganese, magnesium, zinc and silicon and having an aluminum purity of 99.8% by mass or more. The strength of the metal can of the aluminum alloy can be dramatically increased, and thus the wall thickness thereof can be reduced. As a result, a thin and light battery having a high output power and excellent thermal radiation property can be realized.

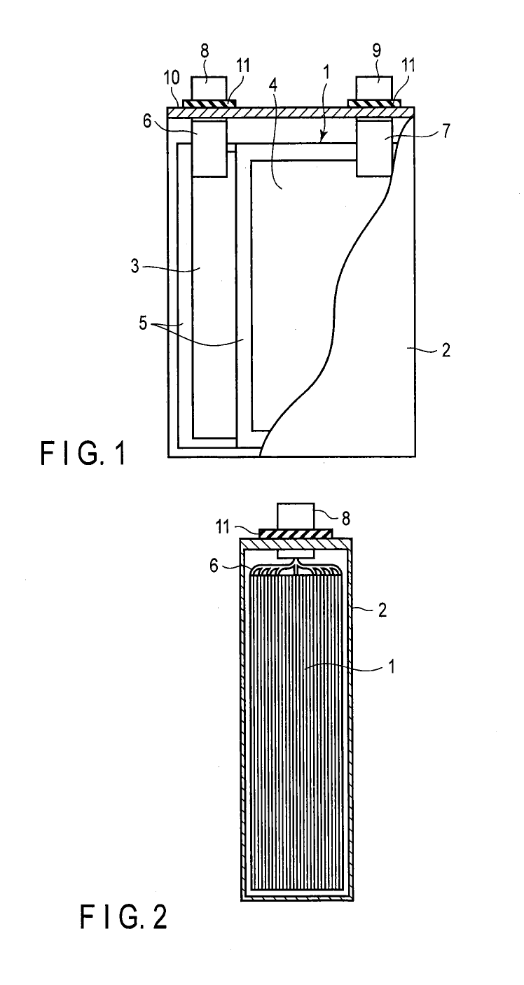

A rectangular secondary battery of the embodiment is shown in FIG. 1 and FIG. 2. As shown in FIG. 1, an electrode group 1 is housed in a rectangular cylindrical metal case 2. The electrode group 1 has a structure in which a positive electrode 3, a negative electrode 4 and a separator 5 placed between them are spirally wound so that the resulting product has a flat shape. Nonaqueous electrolyte (not shown in FIG.) is held in the electrode group 1. As shown in FIG. 2, multiple portions of the edges of the positive electrodes 3, which are located at the edge face of the electrode group 1, are each electrically connected to belt-like positive electrode leads 6. Also, multiple portions of the edges of the negative electrode 4, which are located at this edge face, are each electrically connected to belt-like negative electrode leads 7. The multiple positive electrode leads 6 are bundled together in a group, which is electrically connected to a positive electrode conductive tab 8. A positive electrode terminal is formed of the positive electrode leads 6 and the positive electrode conductive tab 8. The negative electrode leads 7 are bundled together in a group, which is electrically connected to a negative electrode conductive tab 9. A negative electrode terminal is formed of the negative electrode leads 7 and the negative electrode conductive tab 9. A metal sealing plate 10 is fixed to an opening of the metal case 2 by welding or the like. The positive electrode conductive tab 8 and the negative electrode conductive tab 9 are each pulled outside through holes, which are provided in the sealing plate 10. An inner circumferential surface of each hole in the sealing plate 10 is covered with an insulating member, in order to avoid short-circuit caused by contact with the positive electrode conductive tab 8 or the negative electrode conductive tab 9.

The kind of the battery is not limited to the rectangular battery, and various kinds of batteries including cylindrical batteries, slim-type batteries, coin-shaped batteries, and the like can be made. In addition, the shape of the electrode group is not limited to the flat shape, and may be formed into a cylindrical shape, laminated shape, or the like.

The first embodiment as explained above includes the negative electrode including the titanium-containing oxide and the positive electrode including the compound represented by LiFe₁₋ₓMnₓSO₄F wherein 0≦x≦0.2 and having at least one kind of crystal structure selected from the tavoraite crystal structure and the triplite crystal structure, and therefore the nonaqueous electrolyte battery, which has the excellent high-temperature durability, float charge resistance and low-temperature output performance and has the compatibility with a lead storage battery, and whose capacity, SOC, SOD and DOD can be easily detected, can be provided.

### Second Embodiment

A battery pack of a second embodiment includes one or more nonaqueous electrolyte batteries of the first embodiment. The battery pack may have a battery module including multiple batteries. The batteries may be connected either in series or in parallel, and n multiple (n is an integer of 1 or more) of 6 batteries which are connected in series are particularly preferable. When a positive electrode including a compound represented by LiFe₁₋ₓMnₓSO₄F wherein 0≦x≦0.1 and having a tavoraite crystal structure, and a negative electrode including a lithium titanium oxide having a spinel structure are used, a battery having an intermediate voltage of 2 V can be obtained. In this case, the voltage of the battery pack becomes 12 V in the 6 batteries connected in series if n multiple of the 6 batteries are connected in series and a value of n is 1, and thus the compatibility with a lead storage battery pack is remarkably improved. In addition, the battery using the positive electrode and the negative electrode described above has a voltage curve with an appropriate inclination, and thus the capacity, SOC, SOD and DOD thereof can be easily detected by monitoring only the voltage, similar to a lead storage battery. As a result, even in the battery pack in which the number of battery series is n multiple of 6, the affect caused by variation between the batteries can be reduced, and it becomes possible to control the battery by monitoring only the voltage.

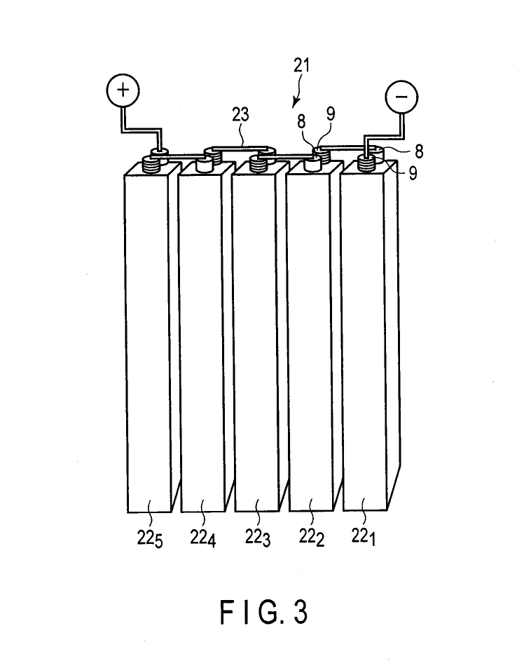

One embodiment of a battery module used in the battery pack is shown in FIG. 3. A battery module 21 shown in FIG. 3 has multiple rectangular secondary batteries 22₁ to 22₅ of the first embodiment. A positive electrode conductive tab 8 of the secondary battery 22₁ is electrically connected to a negative electrode conductive tab 9 of the secondary battery 22₂, which is located next to the battery 22₁, through a lead 23. Further, a positive electrode conductive tab 8 of this secondary battery 22₂ is electrically connected to a negative electrode conductive tab 9 of the secondary battery 22₃, which is located next to the battery 22₂, through the lead 23. The secondary batteries 22₁ to 22₅ are connected in series in this way.

As a casing in which the battery module is housed, a metal can formed of an aluminum alloy, iron or stainless steel, and a plastic case may be used. The case has desirably a plate thickness of 0.5 mm or more.

The embodiments of the battery pack may be arbitrarily changed depending on the use. The battery pack is preferably used for packs which are desirable to have the cycle performance at a large current. Specifically, it is preferably used for a power source for digital cameras, and for car use, such as hybrid electric vehicles with two to four wheels, electric vehicles with two to four wheels, and assist bicycles. It is preferably used for car use.

The second embodiment has the nonaqueous electrolyte battery of the first embodiment, and therefore the battery pack, which has the excellent high-temperature durability, float charge resistance and low-temperature output performance and has the compatibility with a lead storage battery pack, and whose capacity, SOC (state of charge), SOD (state of discharge) or DOD (depth of discharge) can be easily detected, can be realized.

### EXAMPLE

Referring the drawings, Examples will be explained in detail below.

### Example 1

After FeSO₄.7H₂O and MnSO₄.H₂O were mixed in a pre-determined stoichiometric ratio and the mixture was dehydrated at 90° C. in vacuo, LiF was added thereto in a pre-determined stoichiometric ratio, and the mixture was pressure-molded into pellets. After that, the pellets were heat-treated at 290° C. for 24 hours in a nitrogen atmosphere. The obtained product was pulverized in a dry atmosphere, thereby obtaining LiFe_{0.95}Mn_{0.05}SO₄F which had a tavoraite crystal structure and whose primary particle had an average particle size of 0.3 μm. The crystal structure of the synthesized compound was identified by a Rietveld method and an X-ray diffraction pattern.

A positive electrode was produced using the obtained LiFe_{0.95}Mn_{0.05}SO₄F in the following method. Carbon particles having an average particle size of 0.005 μm were bound to surfaces of the LiFe_{0.95}Mn_{0.05}SO₄F particles in a bound amount of 0.1% by mass (based on 100% by mass of the LiFe_{0.95}Mn_{0.05}SO₄F). With the obtained positive electrode active material were mixed 5% by mass (based on the amount of positive electrode) of a graphite powder as a conductive agent and 5% by mass (based on the amount of positive electrode) of PVdF as a binder, and the mixture was dispersed in an n-methyl pyrrolidone (NMP) solvent to prepare a slurry. Both surfaces of an aluminum alloy foil (a purity of 99% by mass) having a thickness of 15 μm were coated with the obtained slurry, which was dried, and a positive electrode having positive electrode material layers whose thicknesses were each 43 μm and having an electrode density of 2.2 g/cm³ was produced after a press step. The positive electrode material layer had a specific surface area of 5 m²/g.

Separately, an Li_{4/3}Ti_{5/3}O₄ powder whose primary particles had an average primary particle size of 0.8 μm, and which had a BET specific surface area of 10 m²/g, a graphite powder having an average particle size of 6 μm as a conductive agent, and PVdF as a binder were mixed in a mass ratio of 95:3:2, the mixture was dispersed in an n-methylpyrrolidone (NMP), and the dispersion was stirred using a ball mill under conditions of the number of rotation of 1000 rpm and a stirring time of 2 hours, to prepare a slurry. An aluminum alloy foil (a purity of 99.3% by mass) having a thickness of 15 μm was coated with the obtained slurry, which was dried, and a negative electrode having negative electrode material layers whose thicknesses were each 59 μm and having an electrode density of 2.2 g/cm³ was produced after a heat-press step. A negative electrode porosity excluding a current collector was 35%. The negative electrode material layer had a BET specific surface area (a surface area per g of the negative electrode material layer) of 5 m²/g.

A method for measuring the particles of the positive electrode active material and the negative electrode active material is shown below.

The particle measurement of the active material was performed using a laser diffraction particle size analyser (Shimadzu SALD-300) by a method of: first adding about 0.1 g of a sample, a surfactant, and 1 to 2 mL of distilled water to a beaker; thoroughly stirring the mixture; pouring the mixture into an agitation bath; measuring the distribution of luminous intensity 64 times at intervals of two seconds; and analyzing the particle size distribution data.

The BET specific surface area by N₂ adsorption was measured under the following conditions.

As a sample, 1 g of a powdery active material, or 2×2 cm² two electrodes (the positive electrode or the negative electrode) cut were used. A BET specific surface area measurement apparatus manufactured by Yuasa-Ionics Co., Ltd was used and nitrogen gas was used as adsorption gas.

Separately, the positive electrode was covered with a regenerated cellulose fiber separator having a thickness of 30 μm, a porosity of 65% and an average fiber diameter of 1 μm, which was formed from pulp as a starting material, and the negative electrode was put on the resulting positive electrode. A ratio (Sp/Sn) of an area of the positive electrode material layer (Sp) to an area of the negative electrode material layer (Sn) was 0.98, and an edge of the negative electrode material layer was protruded from an edge of the positive electrode material layer. The positive electrode, the negative electrode and the separator were spirally wound, thereby producing an electrode group. At this time, an electrode width of the positive electrode material layer (Lp) was 50 mm, an electrode width of the negative electrode material layer (Ln) was 51 mm, and a Lp/Ln was 0.98.

This electrode group was pressed into a flat shape. The resulting electrode group was housed in a case of a thin-type metal can having a thickness of 0.25 mm and formed of an aluminum alloy (an Al purity of 99% by mass).

Separately, liquid nonaqueous electrolyte (nonaqueous electrolytic solution) was prepared by dissolving 1.5 mol/L of lithium tetrafluoroborate (LiBF₄) as a lithium salt in a mixed solvent of propylene carbonate (PC) and γ-butyrolactone (GBL) (a volume ratio of 1:1) as an organic solvent. The nonaqueous electrolyte had a boiling point of 220° C. This nonaqueous electrolyte was poured into the electrode group in the case, thereby producing a rectangular nonaqueous electrolyte secondary battery having a thickness of 10 mm, a width of 50 mm and a height of 90 mm, and having the structure shown in FIG. 1 described above.

### Example 2

After FeSO₄.7H₂O and MnSO₄.H₂O were mixed in a pre-determined stoichiometric ratio and the mixture was dehydrated at 90° C. in vacuo, LiF was added thereto in a stoichiometric ratio, and the mixture was pressure-molded into pellets. After that, the pellets were heat-treated at 290° C. for 24 hours in a nitrogen atmosphere. The obtained product was pulverized in a dry atmosphere, thereby obtaining LiFe_{0.85}Mn_{0.15}SO₄F which had a triplite crystal structure and whose primary particles had an average primary particle size of 0.3 μm. The crystal structure of the synthesized compound was confirmed in the same manner as in Example 1.

Li₃PO₄ particles having an average particle size of 0.005 μm were bound to surfaces of the obtained LiFe_{0.85}Mn_{0.15}SO₄F particles in a bound amount of 0.1% by mass (based on 100% by mass of the LiFe_{0.85}Mn_{0.15}SO₄F). A nonaqueous electrolyte secondary battery was produced in the same manner as in Example 1, except that the obtained positive electrode active material was used.

### Examples 3 to 10 and Comparative Examples 1 to 4

A rectangular secondary battery was produced in the same manner as in Example 1 described above, except that a positive electrode active material, a negative electrode active material and nonaqueous electrolyte shown in Table 1 described below were used.

### Comparative Example 5

In Comparative Example 5, a commercially available lead storage battery (a nominal capacity of 3.4 Ah, 12 V, 1.2 kg) was used.

A discharge capacity and an intermediate voltage (cell voltage) of each secondary battery obtained in Examples 1 to 10 and Comparative Example 2 were measured when it was charged at 25° C. at a constant current of 1 C up to 2.4 V and charged at a constant voltage of 2.4 V (a charging time of 3 hours), and then it was 1 C discharged up to 1.5 V.

In Comparative Examples 1, 3 and 4, a discharge capacity and an intermediate voltage (cell voltage) of the battery were measured when it was charged at 25° C. at a constant current of 1 C up to 4.2 V and charged at a constant voltage of 4.2 V (a charging time of 3 hours), and then it was 1 C discharged up to 3.0 V.

In Examples 1 to 10 and Comparative Examples 1 to 4, battery packs were obtained by producing a battery module in which 6, 5 or 3 batteries obtained each in Examples 1 to 10 and Comparative Examples 1 to 4 were connected in series. The number of secondary battery series in the battery pack was set as the number of the secondary batteries which does not provide an overcharge (more than 100% charge) at an end-of-charge voltage of 14.4 V, in order to have the compatibility with an end-of-charge voltage (14.4 V) of a 12 V lead storage battery.

A voltage of the battery pack in each of Examples 1 to 10 and Comparative Examples 1 to 4 was measured in a 50% SOD (state of discharge) obtained by charging the battery pack at a constant current of 1 C up to 14.4 V, charging it at a constant voltage of 14.4 V (a charging time of 3 hours), and 1 C discharging it to a 50% SOD (state of discharge). The results are shown in Table 2.

In a high-temperature float charge test, the battery in each of Examples 1 to 10 and Comparative Examples 2 and 5 was float charged at a constant voltage of 2.25 V (100% SOC), and the battery in each of Comparative Examples 1, 3 and 4 was charged at a constant voltage of 4.2 V (100% SOC) in a 60° C. environment, and then a cell capacity thereof was measured at 25° C. at a 1 C discharge every week, and the time at which a capacity maintenance rate reached 80% was defined as a durability life.

In a low-temperature performance test, a discharge capacity was measured when the battery was 10 C discharged in a −30° C. environment. A capacity maintenance rate was obtained from the discharge capacity obtained above, a discharge capacity obtained in a 1 C discharge test at 25° C. being assumed as 100%.

These measurement results are shown in Table 2. FeFₓ, which was used as a coating in Example 5, satisfied a range of 1≦x≦3.

TABLE 1

| | Positive electrode | | Negative electrode | |
|---|---|---|---|---|
| | active material/coating | Crystal structure | active material | Nonaqueous electrolyte |
| Example 1 | LiFe_{0.95}Mn_{0.05}SO₄F/C | tavoraite | Li_{4/3}Ti_{5/3}O₄ | 1.5M LiBF₄-PC/GBL(1:2) |
| Example 2 | LiFe_{0.85}Mn_{0.15}SO₄F/Li₃PO₄ | triplite | Li_{4/3}Ti_{5/3}O₄ | 1.5M LiBF₄-PC/GBL(1:2) |
| Example 3 | LiFe_{0.95}Mn_{0.05}SO₄F/Al₂O₃ | tavoraite | Li_{4/3}Ti_{5/3}O₄ | 1.5M LiBF₄-PC/GBL(1:2) |
| Example 4 | LiFe_{0.95}Mn_{0.05}SO₄F/LiF | tavoraite | Li_{4/3}Ti_{5/3}O₄ | 1.5M LiBF₄-PC/GBL(1:2) |
| Example 5 | LiFe_{0.95}Mn_{0.05}SO₄F/FeFₓ | tavoraite | Li_{4/3}Ti_{5/3}O₄ | 1.5M LiBF₄-PC/GBL(1:2) |
| Example 6 | LiFe_{0.95}Mn_{0.05}SO₄F/SiP₂O₇ | tavoraite | Li_{4/3}Ti_{5/3}O₄ | 1.5M LiBF₄-PC/GBL(1:2) |
| Example 7 | LiFeSO₄F | tavoraite | Li_{4/3}Ti_{5/3}O₄ | 1.5M LiBF₄-PC/GBL(1:2) |
| Example 8 | LiFe_{0.95}Mn_{0.05}SO₄F/C | tavoraite | TiO₂(B) | 1.5M LiPF₆-PC/DEC(1:2) |
| Example 9 | LiFe_{0.95}Mn_{0.05}SO₄F/C | tavoraite | TiO₂(B) | 1.5M LiPF₆-PC/DEE(1:2) |
| Example 10 | LiFe_{0.95}Mn_{0.05}SO₄F/C | tavoraite | Nb₃TiO₇ | 1.5M LiPF₆-PC/DEC(1:2) |
| Comparative | LiFePO₄/C | olivine | Graphite | 1.5M LiPF₆-PC/DEC(1:2) |
| Example 1 | | | | |
| Comparative | LiFePO₄/C | olivine | Li_{4/3}Ti_{5/3}O₄ | 1.5M LiBF₄-PC/GBL(1:2) |
| Example 2 | | | | |
| Comparative | LiMn₂O₄ | spinel | Graphite | 1.5M LiBF₄-EC/GBL(1:2) |
| Example 3 | | | | |
| Comparative | LiCoO₂ | layered | Graphite | 1.5M LiBF₄-EC/GBL(1:2) |
| Example 4 | | | | |
| Comparative | PbO₂ | orthorhombic system | Pb | Sulfuric acid |
| Example 5 | | | | |

TABLE 2

| | | | | | 10 C discharge |
|---|---|---|---|---|---|
| | 1 C discharge test at 25° C. | | 100% SOC float charge at 60° C. | | test at −30° C. |
| | Discharge capacity | Cell voltage | Pack voltage | Durability life | Discharge capacity |
| | (Ah) | (V) | (V) | (month) | (Ah) |
| Example 1 | 2.5 | 2.0 | 12 (6 batteries | 60 | 80 |
| | | | connected in series) | | |
| Example 2 | 2.4 | 2.35 | 11.75 (5 batteries | 90 | 70 |
| | | | connected in series) | | |
| Example 3 | 2.4 | 2.0 | 12 (6 batteries | 70 | 65 |
| | | | connected in series) | | |
| Example 4 | 2.4 | 2.0 | 12 (6 batteries | 65 | 70 |
| | | | connected in series) | | |
| Example 5 | 2.5 | 2.0 | 12 (6 batteries | 65 | 80 |
| | | | connected in series) | | |
| Example 6 | 2.4 | 2.0 | 12 (6 batteries | 90 | 80 |
| | | | connected in series) | | |
| Example 7 | 2.3 | 2.0 | 12 (6 batteries | 50 | 50 |
| | | | connected in series) | | |
| Example 8 | 2.8 | 2.0 | 12 (6 batteries | 55 | 70 |
| | | | connected in series) | | |
| Example 9 | 2.8 | 2.0 | 12 (6 batteries | 50 | 90 |
| | | | connected in series) | | |
| Example 10 | 3.0 | 2.0 | 12 (6 batteries | 60 | 80 |
| | | | connected in series) | | |
| Comparative | 2.6 | 3.3 | 9.9 (3 batteries | 6 | 0 |
| Example 1 | | | connected in series) | | |
| Comparative | 2.5 | 1.8 | 10.8 (6 batteries | 30 | 20 |
| Example 2 | | | connected in series) | | |
| Comparative | 2.4 | 3.8 | 11 (3 batteries | 1 | 0 |
| Example 3 | | | connected in series) | | |
| Comparative | 3.0 | 3.7 | 11 (3 batteries | 2 | 0 |
| Example 4 | | | connected in series) | | |
| Comparative | 2.1 | 2.0 | 12 (6 batteries | 6 | 0 |
| Example 5 | | | connected in series) | | |

As apparent from Table 2, the batteries in Examples 1 to 10 have the superior durability life (cycle life) in a float charge at a high temperature such as 60° C., and the high-rate discharge performance in a low-temperature environment, to those in Comparative Examples 1 to 5.

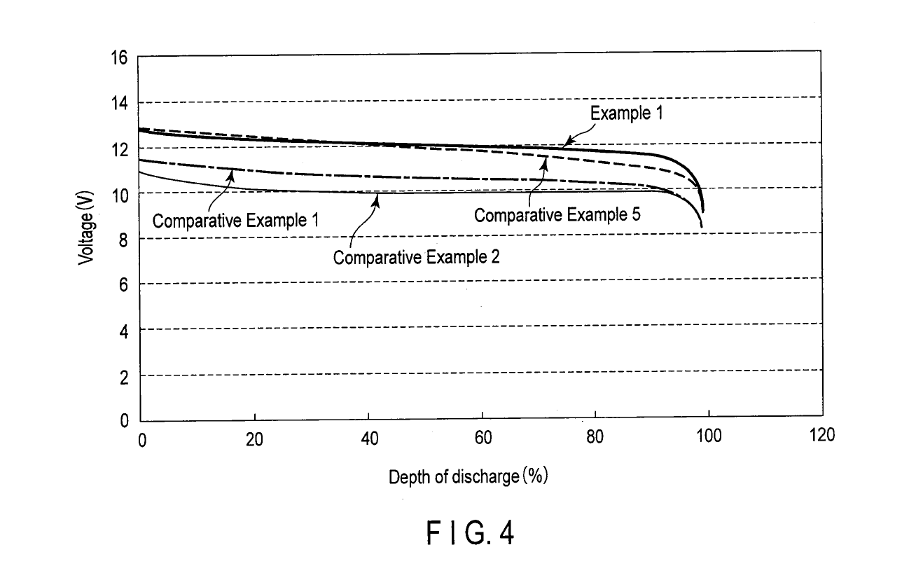

In FIG. 4, 1 C discharge curves of the battery packs of Example 1 and Comparative Examples 1, 2 and 5, in which the horizontal axis shows a depth of discharge (%) and the vertical axis shows a voltage (V), are shown. The discharge curve of the battery pack of Example 1 is approximate to the discharge curve of the lead storage battery pack of Comparative Example 5, and therefore the battery pack of Example 1 has an excellent compatibility with the lead storage battery pack. Also the discharge curve of the battery pack of Example 1 has higher flatness than that of the lead storage battery pack of Comparative Example 5, and it is therefore found that it has the high stability at a discharge voltage of 12 V. On the other hand, the battery packs of Comparative Examples 1 and 2 have lower discharge voltages than that of the lead storage battery pack of Comparative Example 5, and it is therefore found that they have the poor compatibility with the lead storage battery pack.

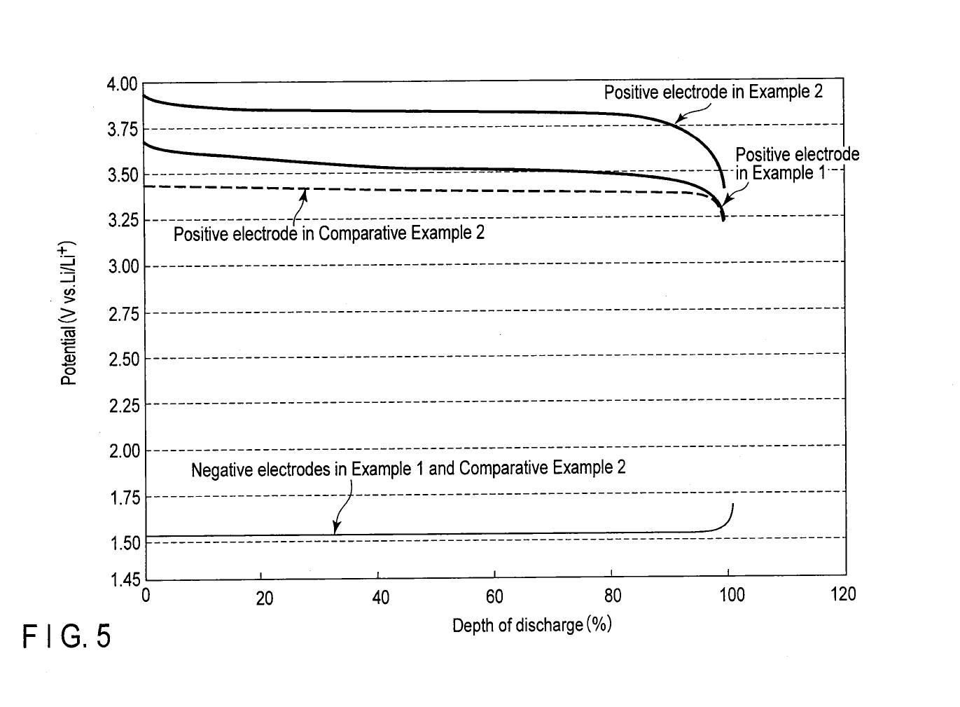

Potential curves of the positive electrode and the negative electrode in Examples 1 and 2 are shown in FIG. 5. In FIG. 5, the horizontal axis shows a depth of discharge (%) and the vertical axis shows a potential (V vs. Li/Li⁺). The positive electrode active material in Example 1 has a lithium absorption-release potential of 3.55 (V vs. Li/Li⁺); the positive electrode active material in Example 2 has a lithium absorption-release potential of 3.85 (V vs. Li/Li⁺); and the positive electrode active material in Comparative Example 2 has a lithium absorption-release potential of 3.45 (V vs. Li/Li⁺). On the other hand, the negative electrode active materials in Examples 1 and 2, and Comparative Example 2 have a lithium absorption-release potential of 1.55 (V vs. Li/Li⁺). Thus, the intermediate voltages (a battery voltage at a depth of discharge of 50%) of Examples 1 and 2, and Comparative Example 2 are respectively 2.0 V, 2.35 V and 1.8 V. The intermediate voltage of the battery of Example 1, accordingly, is the same as the intermediate voltage of the lead storage battery, and thus the battery of Example 1 has the most excellent compatibility with the lead storage battery.

As apparent from FIG. 5, the lithium absorption potentials of the positive electrode active materials of Examples 1 and 2 are gradually lowered after the depth of discharge exceeds 80%. As the voltages of the batteries of Examples 1 and 2 are gradually lowered when the depth of discharge reaches 80%, therefore, it is possible to easily detect the capacity and the depth of discharge (DOD) from voltage variations (see FIG. 4). On the other hand, the lithium absorption potential of the positive electrode active material in Comparative Example 2 keeps plateau even if the depth of discharge exceeds 80%, and it suddenly drops down when the depth of discharge approaches near 100%. As shown in FIG. 4, therefore, the voltage of the battery of Comparative Example 2 is suddenly decreased when the depth of discharge exceeds 90%. Thus, it is difficult for the battery of Comparative Example 2 to detect the capacity and the depth of discharge (DOD) in a high precision from voltage variations.

The nonaqueous electrolyte battery according to at least one of the embodiments and Examples described above includes the negative electrode including the titanium-containing oxide, and the positive electrode including a compound, which is represented by LiFe₁₋ₓMnₓSO₄F wherein 0≦x≦0.2, and has at least one kind of crystal structure selected from the tavoraite crystal structure and the triplite crystal structure, and thus the nonaqueous electrolyte battery, which has the excellent high-temperature float charge performance and low-temperature high-rate discharge performance and the compatibility with the lead storage battery, and whose capacity can be easily detected, can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A nonaqueous electrolyte battery comprising:
a positive electrode comprising a compound, which is represented by LiFe₁₋ₓMnₓSO₄F wherein 0≦x≦0.2, and has at least one kind of crystal structure selected from tavoraite and triplite;
a negative electrode comprising a titanium-containing oxide; and
a nonaqueous electrolyte.

2. The battery according to claim 1,
wherein the value of x satisfies 0≦x≦0.1.

3. The battery according to claim 1,
wherein the value of x satisfies 0.1≦x≦0.2.

4. The battery according to claim 1,
wherein the positive electrode comprises particles of the compound.

5. The battery according to claim 1,
wherein the positive electrode comprises:
particles of the compound;
a coating which covers at least a part of a surface of the particles of the compound, and comprises at least one kind of material selected from the group consisting of a carbon material, a phosphorus compound, a fluoride and a metal oxide.

6. The battery according to claim 5,
wherein the coating comprises at least one kind of material selected from the group consisting of a carbonaceous material having a d₀₀₂ of 0.344 nm or more, Li₃PO₄, AlPO₄, SiP₂O₇, LiF, AlF₃, FeF_{X} wherein 2≦X≦3, Al₂O₃, ZrO₂, SiO₂ and TiO₂.

7. The battery according to claim 5,
wherein an amount of the coating is within a range of 0.001 to 3% by mass based on an amount of the particles of the compound.

8. The battery according to claim 1,
wherein the titanium-containing oxide is at least one kind of oxide selected from the group consisting of Li_{4/3+x}Ti_{5/3}O₄ wherein 0≦x≦1, LiₓTiO₂ wherein 0≦x≦1, and LiₓNbₐTiO₇ wherein 0≦x and 1≦a≦4.

9. The battery according to claim 1,
wherein the titanium-containing oxide is at least one kind of oxide selected from the group consisting of a lithium titanium oxide having a spinel structure, a titanium oxide having a bronze structure (B), a titanium oxide having an anatase structure, a niobium titanium oxide, and a lithium titanium oxide having a ramsdellite structure.

10. The battery according to claim 4,
wherein the compound has an average primary particle size within a range of 0.05 to 1 μm.

11. A battery pack comprising a battery module comprising 6 n or 5 n, in which n is 1 or more, of the nonaqueous electrolyte batteries according to claim 1 which are connected in series.
